(19) United States
(12) Patent Application Publication
(10) Pub. No.: US 2025/0303535 A1
(43) Pub. Date: Oct. 2, 2025

(54) DURABLE TORQUE TOOL

(71) Applicant: MATATAKITOYO TOOL CO., LTD., Taichung City (TW)

(72) Inventor: YI-MIN WU, Taichung City (TW)

(21) Appl. No.: 18/624,132

(22) Filed: Apr. 2, 2024

(51) Int. Cl. B25B 23/142

(52) U.S. Cl. CPC B25B 23/1427

(57) ABSTRACT

A torque tool includes a tubular handle, a hollow head, a rod and a rotating unit. The hollow head includes a tubular portion for receiving a section of the tubular handle. The rod includes a middle section pivotable in the tubular handle, a terminal section extending in the tubular portion, an extensive portion extending from the terminal section, and a concave portion located next to the extensive portion. The extensive and concave portions are located in the hollow head. The rotating unit includes a lever pivotable in the hollow head, a long protuberance extending from the lever, and a cutout located next to the long protuberance. The cutout receives the extensive portion. The long protuberance extends in the concave portion. The abrasion-resistant element includes a first portion in contact with the extensive portion and a second portion in contact with the long protuberance.

### BACKGROUND OF INVENTION

### 1. Field of Invention

The present invention relates to a torque tool and, more particularly, to a durable torque tool.

### 2. Related Prior Art

Referring to FIG. 7, another conventional torque tool 90 includes a tubular handle 91, a pivot 92, a hollow head 93, a rod 95 and a rotating unit 97 in addition to the adjustment mechanism 86. The hollow head 93 is separated from the rod 95. The hollow head 93 includes a tubular portion 94 for receiving the tubular handle 91 so that the hollow head 93 is not pivotable relative to the tubular handle 91. Hence the hollow head 93 does not hit or damage the tubular handle 91.

The rod 95 is partially inserted in the tubular handle 91. The pivot 92 is inserted in the tubular portion 94 and the tubular handle 91, thereby pivotally connecting the hollow head 93 to the tubular handle 91. The rod 95 includes a rounded end 96 extending in the hollow head 93 from the tubular handle 91. The rod 95 includes another end (not numbered) in contact with the adjustment mechanism 86.

The rotating unit 97 includes a lever 98 instead of the combination of the toothed wheel with the pawls. The lever 98 includes a recess 99 for receiving the rounded end 96. The tongue 88 is connected to the rotating unit 97. The tongue 88 is engageable with a nut or a head of a screw via a socket.

A force is exerted on the tubular handle 91 to provide a torque for driving the nut or screw via the tongue 88.

As the torque reaches an adjustable limit, the rod 95 shakes off the adjustment mechanism 86 and hits the tubular handle 91 to provide a sound. The sound draws attention from a user of the torque tool 90 that the torque has reached the adjustable limit.

However, there is friction between a concave face of the recess 99 wears against a convex face of the rounded end 96. This friction inevitably causes the recess 99 and the rounded end 96 to wear away each other. Moreover, the friction comprises precision in pivoting the rod 95 relative to the adjustment unit 86 when the adjustable limit is reached.

The present invention is therefore intended to obviate or at least alleviate the problems encountered in the prior art.

### SUMMARY OF INVENTION

It is the primary objective of the present invention to provide a durable torque tool.

To achieve the foregoing objective, the torque tool includes a tubular handle, a hollow head, a rod and a rotating unit. The hollow head includes a tubular portion for receiving a section of the tubular handle. The rod includes a middle section pivotable in the tubular handle, a terminal section extending in the tubular portion, an extensive portion extending from the terminal section, and a concave portion located next to the extensive portion. The extensive and concave portions are located in the hollow head. The rotating unit includes a lever pivotable in the hollow head, a long protuberance extending from the lever, and a cutout located next to the long protuberance. The cutout receives the extensive portion. The long protuberance extends in the concave portion. The abrasion-resistant element includes a first portion in contact with the extensive portion and a second portion in contact with the long protuberance.

In another aspect, the rotating unit includes a short protuberance extending from the lever, and the cutout is located between the long and short protuberances.

In another aspect, the extensive portion includes a side made with a recess for receiving the first portion of the abrasion-resistant element. Alternatively, the long protuberance includes a side made with a recess for receiving the second portion of the abrasion-resistant element.

In another aspect, the abrasion-resistant element is a roller. Alternatively, the abrasion-resistant element is a ball.

In another aspect, the abrasion-resistant element is made of a hard material. More particularly, the hard material is SUJ2 bearing steel.

Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is a partial, cut-away view of a torque tool according to the first embodiment of the present invention;

FIG. 2 is a partial, cross-sectional view of the torque tool shown in FIG. 1;

FIG. 3 is a partial, cross-sectional view of a torque tool according to the second embodiment of the present invention;

FIG. 4 is a partial, cross-sectional view of a torque tool according to the third embodiment of the present invention;

FIG. 5 is another partial, cross-sectional view of the torque tool shown in FIG. 1;

FIG. 6 is a partial, cross-sectional view of a torque tool according to the fourth embodiment of the present invention; and

FIG. 7 is a partial, cross-sectional view of another conventional torque tool.

### DETAILED DESCRIPTION OF EMBODIMENTS

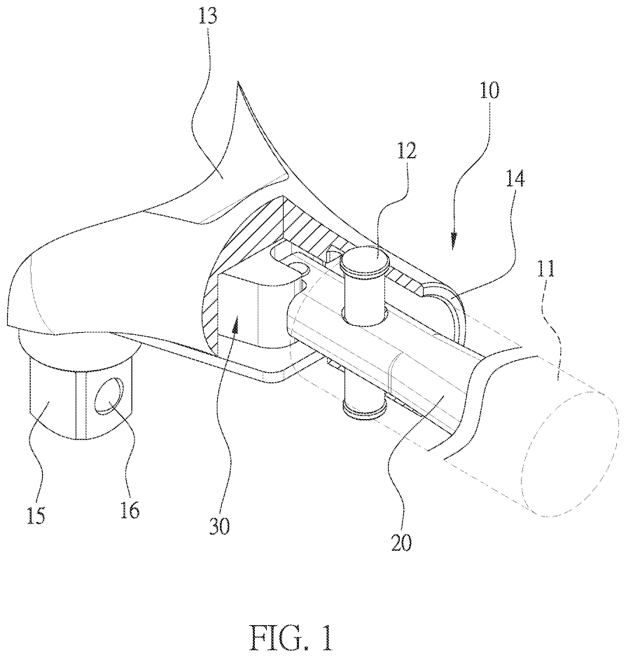

Referring to FIGS. 1, 2 and 5, a torque tool 10 includes a tubular handle 11, a pivot 12, a hollow head 13, a rod 20, a rotating unit 30 and an adjustment mechanism 40 according to a first embodiment of the present invention.

The hollow head 13 includes a tubular portion 14 extending from the periphery of an annular portion (not numbered). The tubular portion 14 is in communication with the annular portion. Two covers (not shown) are preferably used to cover two openings (numbered) of the annular portion as disclosed in US Publication No. 2014/0047957.

The tubular handle 11 includes a first terminal section inserted in the tubular portion 14. The pivot 12 is inserted in the tubular portion 14 and the tubular handle 11, thereby connecting the hollow head 13 to the tubular handle 11. The tubular handle 11 is not pivotable relative to the hollow head 13, thereby preventing them from wearing away each other. The tubular handle 11 includes a second terminal section for receiving the adjustment mechanism 40.

The pivot 12 is preferably a rivet. However, the pivot 12 can be replaced with a pin, a screw, a combination of a screw with a nut, or any other proper devices.

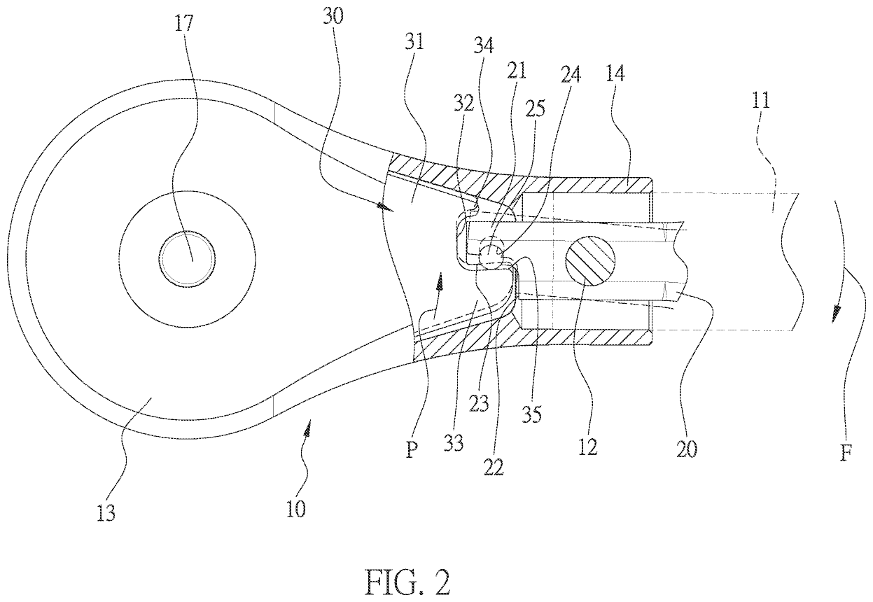

Referring to FIGS. 1 and 2, the rod 20 is inserted in the tubular handle 11. A first terminal section of the rod 20 is inserted in the first terminal section of the tubular handle 11. The pivot 12 is inserted in first terminal section of the rod 20.

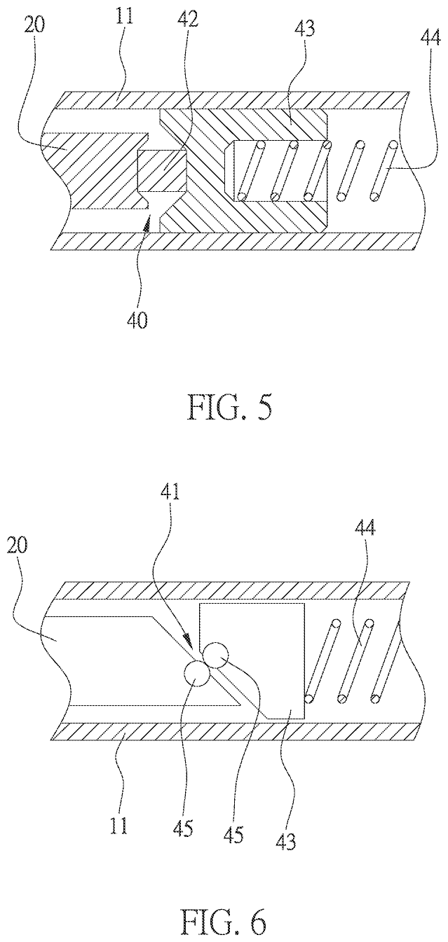

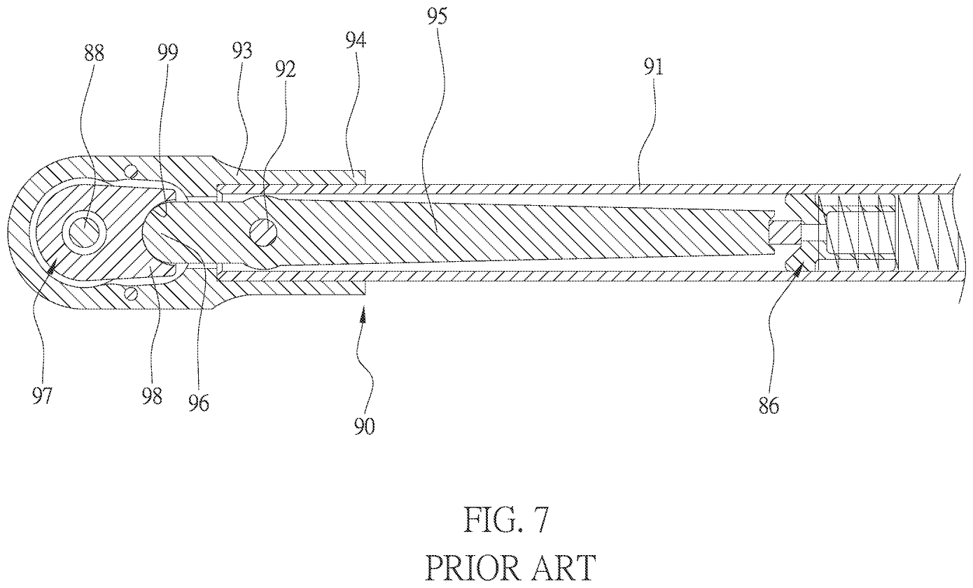

A second terminal section of the rod 20 is inserted in the second terminal section of the hollow handle 11. The second terminal section of the rod 20 is in contact with the cube 42 of the adjustment mechanism 40 (FIG. 5). Alternatively, the roller 45 which is rollable in the recess made in the slope formed on the rod 20 is in contact with the roller 45 which is rollable in the recess made in the slope formed on the wedge 43 (FIG. 6).

The first terminal section of the rod 20 is inserted in the hollow head 13. The first terminal section of the rod 20 is formed with an extensive portion 21, a concave portion 22 and a recess 24. The extensive portion 21 is located next to the concave portion 22. The recess 24 is made in a side 23 of the extensive portion 21 which faces the concave portion 22. The recess 24 is preferably a semi-spherical recess for receiving an abrasion-resistant element 25.

The abrasion-resistant element 25 includes a first portion inserted in the recess 24 and a second portion located out of the recess 24. The first portion of the abrasion-resistant element 25 is at least marginally larger than the second portion of the abrasion-resistant element 25 so that abrasion-resistant element 25 is allowed to roll relative to the rod 20 without any risk of leaving the rod 20. The abrasion-resistant element 25 can be a roller or a ball. The abrasion-resistant element 25 is made of a hard material such as CNS (or JIS) SUJ2 bearing steel or any other proper material.

The rotating unit 30 includes a rotor (not numbered), a lever 31, a square tongue 15, a detent 16 and a button 17. The lever 31 extends from the periphery of the rotor. The square tongue 15 extends from a lower face of the rotor. The detent 16 is preferably a ball including a first portion movable in a transverse bore (not numbered) made in the square tongue 15 and a second portion movable out of the transverse bore of the square tongue 15. The button 17 includes a lower section movable in a longitudinal bore made in the square tongue 15 and an upper section extensible from the longitudinal bore of the square tongue 15.

Normally, the lower section of the button 17 abuts against the first portion of the detent 16 so that the second portion of the detent 16 protrudes from the square tongue 15. In operation, the upper section of the button 17 is pushed so that a recess (not shown) made in the lower section of the button 17 receives the first portion of the detent 16 to allow the second portion of the detent 16 to enter the transverse bore of the square tongue 15 to allow the square tongue 15 to be partially inserted in a square bore made in a socket. Then, the upper section of the button 17 is released, thereby allowing the lower section of the button 17 to abut against the first portion of the detent 16 so that the second portion of the detent 16 protrudes from the square tongue 15 to abut against an internal portion of the socket.

The lever 31 preferably includes a cutout 32 between a long protuberance 33 and a short protuberance 34. The long protuberance 33 and the short protuberance 34 extend from a free end of the lever 31, in parallel to each other. The long protuberance 33 includes an internal side 35 facing the short protuberance 34 and an external side (not numbered) opposite to the internal side 35.

The lever 31 is pivotable in the hollow head 13. The long protuberance 33 of the lever 31 is located in the concave portion 22 of the rod 20. The cutout 32 of the lever 31 receives the extensive portion 21 of the rod 20 so that the extensive portion 21 is located between the long protuberance 33 and the short protuberance 34. The abrasion-resistant element 25 is in contact with the extensive portion 21 at an end and in contact with the long protuberance 33 at another end.

A force F is exerted on the tubular handle 11 to rotate the tubular handle 11 and the hollow head 13. Thus, the torque tool 10 is used to provide a torque for tightening or slackening a workpiece such as a nut or a screw. The workpiece exerts a counter force P via the rotating unit 30. The counter force P is larger than the force F. The long protuberance 33 is moved to a new position shown in phantom lines from an original position shown in solid lines. The short protuberance 34 does not prevent the rod 20 from hitting the tubular handle 11 to make a sound for warning of the torque reaching an adjustable limit.

Advantageously, the area of the contact of the abrasion-resistant element 25 with the long protuberance 33 is very small. Thus, damage of the elements of the torque tool 10 is minimized, and so is the waste of energy for operating the torque tool 10.

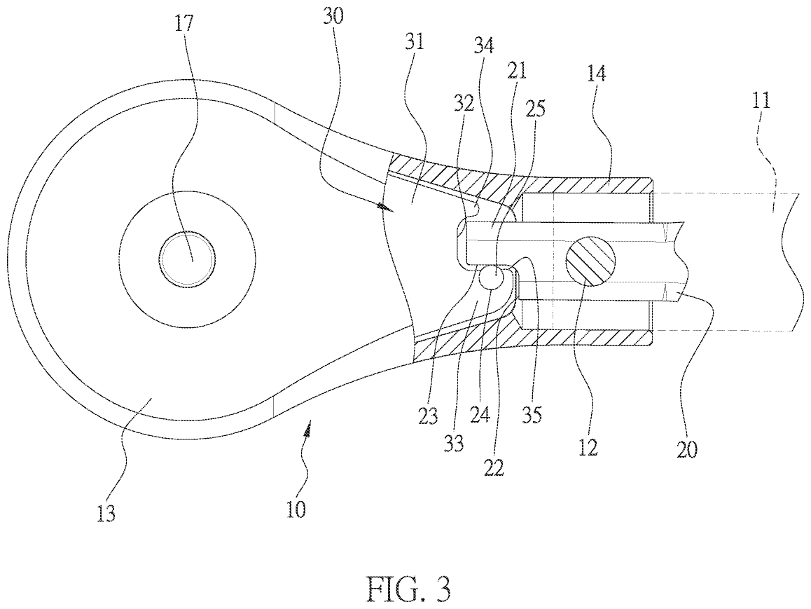

Referring to FIG. 3, there is a torque tool 10 according to a second embodiment of the present invention. The second embodiment is like the first embodiment except for that the recess 24 is made in the internal side 35 of the long protuberance 33 of the lever 31 instead of the side 23 of the extensive portion 21 of the rod 20.

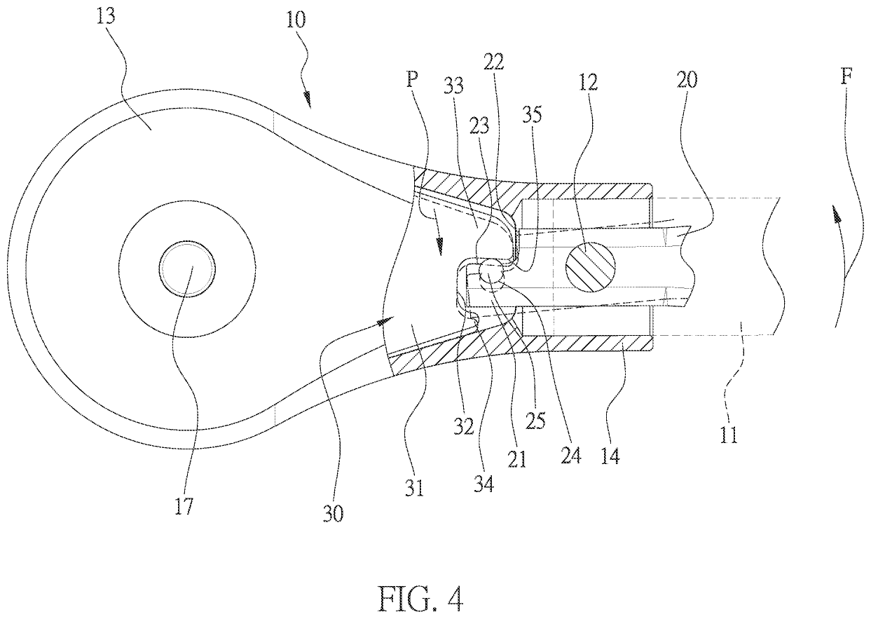

Referring to FIG. 4, there is a torque tool 10 according to a third embodiment of the present invention. The third embodiment is like the first embodiment except for that the extensive portion 21 is switched with the concave portion 22 regarding the positions. Accordingly, the long protuberance 33 and the short protuberance 34 are switched regarding the positions. The concave portion 22 still receives the long protuberance 33, and the cutout 32 still receives the extensive portion 21. The abrasion-resistant element 25 is still in contact with the internal side 35 of the long protuberance 33.

Referring to FIG. 5, the adjustment mechanism 40 includes a cube 42, a saddle 43 and a spring 44 according to the first embodiment. The saddle 43 is movable in the tubular handle 11. The spring 44 is operable to push the saddle 43 and the cube 42 toward the hollow head.

Referring to FIG. 6, a torque tool includes a torque tool according to a fourth embodiment of the present invention. The second embodiment is like the first embodiment except for including an adjustment mechanism 41 instead of the adjustment mechanism 40. The adjustment mechanism 41 includes two rollers 45 and two wedges 43 in addition to the spring 44. One of the rollers 45 is rollable in a recess made in a slope formed at an end of the rod 20. The other roller 45 is rollable in a recess made in a slope formed on the wedge 43. The spring 44 brings the rollers 45 into contact with each other.

The present invention has been described through the illustration of the embodiments. Those skilled in the art can derive variations from the embodiments without departing from the scope of the present invention. Therefore, the embodiments shall not limit the scope of the present invention defined in the claims.

1. A torque tool comprising:
a tubular handle;
a hollow head comprising a tubular portion for receiving a section of the tubular handle;
a rod comprising a middle section pivotable in the tubular handle, a terminal section extending in the tubular portion, an extensive portion extending from the terminal section, and a concave portion located next to the extensive portion, wherein the extensive and concave portions are located in the hollow head;
a rotating unit comprising a lever pivotable in the hollow head, a long protuberance extending from the lever, and a cutout located next to the long protuberance, wherein the cutout receives the extensive portion, wherein the long protuberance extends in the concave portion; and
an abrasion-resistant element comprising a first portion in contact with the extensive portion and a second portion in contact with the long protuberance.

2. The torque tool according to claim 1, wherein the rotating unit comprises a short protuberance extending from the lever, wherein the cutout is located between the long and short protuberances.

3. The torque tool according to claim 1, wherein the extensive portion comprises a side made with a recess for receiving the first portion of the abrasion-resistant element.

4. The torque tool according to claim 1, wherein the long protuberance comprises a side made with a recess for receiving the second portion of the abrasion-resistant element.

5. The torque tool according to claim 1, wherein the abrasion-resistant element is a roller.

6. The torque tool according to claim 1, wherein the abrasion-resistant element is a ball.

7. The torque tool according to claim 1, wherein the abrasion-resistant element is made of a hard material.

8. The torque tool according to claim 7, wherein the hard material is SUJ2 bearing steel.
